(19) United States
(12) Patent Application Publication
(10) Pub. No.: US 2025/0139407 A1
(43) Pub. Date: May 1, 2025

(54) Method, System, and Computer Program Product for Removing Fake Features in Deep Learning Models

(71) Applicant: Visa International Service Association, San Francisco, CA (US)

(72) Inventor: Pei Yang, Austin, TX (US)

(21) Appl. No.: 18/386,011

(22) Filed: Nov. 1, 2023

(51) Int. Cl. G06N 3/045; G06Q 20/40

(52) U.S. Cl. CPC G06N 3/045; G06Q 20/40

(57) ABSTRACT

Methods, systems, and computer program products may obtain a machine learning model, a training dataset including a time range and a feature set including a number of features, and a number times to split the training dataset; for each feature in the feature set, determine, based on a difference between a first trained model including the machine learning model trained on the training dataset with that feature and a second trained model including the machine learning model trained on the training dataset without that feature, whether to update the training dataset to include an updated feature set by removing the feature from the feature set of the training dataset; train the machine learning model on the training dataset including the updated feature set to generate a trained machine learning model; and provide the trained machine learning model.

### BACKGROUND

### 1. Field

This disclosure relates to deep learning models and, in some non-limiting embodiments or aspects, to methods, systems, and computer program products for removing “fake” features in deep learning models.

### 2. Technical Considerations

Deep learning models, such as those used in Fin-Tech and/or the like, may involve a large number of features. The large amount of training data makes it possible to apply large deep learning models with many features in real-world applications. However, in many situations, not all features in a deep learning model are truly related to the output that the model is trying to predict. In practice, some features only appear to be “useful” for prediction. However, the performance of the model with such “fake” features may be worse if for a different time period.

### SUMMARY

Accordingly, provided are improved systems, devices, products, apparatus, and/or methods for removing “fake” features in deep learning models.

According to some non-limiting embodiments or aspects, provided is a method, including: obtaining, with at least one processor, a machine learning model M, a training dataset D₀₀ including a time range [T₀, T] and a feature set F including a number k of features X, and a number Nₛₚₗᵢₜ of times to split the training dataset D₀₀; for each feature Xₓ in the feature set F, determining, with the at least one processor, based on a difference between a first trained model Model(D) including the machine learning model M trained on the training dataset Doo with that feature Xₖ and a second trained model Model(D′) including the machine learning model M trained on the training dataset Doo without that feature Xₖ, whether to update the training dataset Doo to include an updated feature set F′ by removing the feature Xₖ from the feature set F of the training dataset D₀₀; training, with the at least one processor, the machine learning model M on the training dataset D₀₀ including the updated feature set F′ to generate a trained machine learning model M′; and providing, with the at least one processor, the trained machine learning model M′.

In some non-limiting embodiments or aspects, for each feature Xₓ in the feature set F, determining whether to update the training dataset D₀₀ to include an updated feature set F′ by removing the feature Xₖ from the feature set F of the training dataset D₀₀ may include: for each of an integer i from the integer i equals zero to the integer i equals Nₛₚₗᵢₜ: splitting the training dataset D₀₀ the integer i times to generate 2ⁱ split-datasets, wherein each split-dataset D_{i,j} of the 2ⁱ split-datasets is a number j dataset obtained by splitting the training dataset D₀₀ into the [symbol] split-datasets; for each of the number j from the number j equals zero to the number j equals 2ⁱ−1: training the machine learning model M with the split-dataset D_{i,j} to generate a first trained model Model(D_{i,j}); removing the feature Xₖ from the feature set F of the split-dataset D_{i,j} to generate a sub-dataset D′_{i,j}; training the model M with the sub-dataset D′_{i,j} to generate a second trained model Model (D′_{i,j}); determining a first loss Loss(D_{i,j}) for the first trained model Model(D_{i,j}); determining a second loss Loss(D′_{i,j}) for the second trained model Model(D′_{i,j}); determining a difference in loss(DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and adding the difference in loss (DIL_{k,i,j}) for the feature Xₓ to a vector Vₖ for the feature Xₖ; for each vector Vₖ: applying an outlier analysis to the vector Vₖ to identify a number of outliers included in the vector Vₖ; and in response to the number of outliers identified in the vector Vₖ satisfying a threshold outlier number, updating the training dataset D₀₀ to include an updated feature set F′ by removing the feature Xₖ from the feature set F of the training dataset D₀₀.

In some non-limiting embodiments or aspects, applying the outlier analysis to the vector Vₖ to identify the number of outliers included in the vector Vₖ includes calculating a mean μ and a standard deviation μ of the difference in loss (DIL_{k,i,j}) for the feature Xₖ in the vector Vₖ for the feature Xₖ, and wherein an element of the vector Vₖ for the feature Xₖ is determined as an outlier in response to that element being a point outside the range (μ−3σ,μ3σ).

In some non-limiting embodiments or aspects, the threshold outlier number is one.

In some non-limiting embodiments or aspects, the training dataset Doo includes prior transaction data associated with a plurality of prior transactions processed in an electronic payment network during the time range [T₀, T].

In some non-limiting embodiments or aspects, the method further includes:

receiving, with the at least one processor, current transaction data associated with a current transaction initiated in the electronic payment network, wherein the current transaction data includes the updated feature set F′, and wherein the updated feature set F′ includes parameters associated with the current transaction; processing, with the at least one processor, using the trained machine learning model M′, the current transaction data to determine whether to authorize or deny the current transaction; and authorizing or denying, with the at least one processor, in the electronic payment network, the current transaction.

According to some non-limiting embodiments or aspects, provided is a system, comprising: at least one processor coupled to a memory and configured to: obtain a machine learning model M, a training dataset D₀₀ including a time range [T₀, T] and a feature set F including a number k of features X, and a number Nₛₚₗᵢₜ of times to split the training dataset D₀₀; for each feature Xₖ in the feature set F, determine, based on a difference between a first trained model Model(D) including the machine learning model M trained on the training dataset D₀₀ with that feature Xₖ and a second trained model Model (D′) including the machine learning model M trained on the training dataset D₀₀ without that feature Xₖ, whether to update the training dataset D₀₀ to include an updated feature set F′ by removing the feature Xₖ from the feature set F of the training dataset D₀₀; train the machine learning model M on the training dataset D₀₀ including the updated feature set F′ to generate a trained machine learning model M′; and provide the trained machine learning model M′.

In some non-limiting embodiments or aspects, for each feature Xₖ in the feature set F, the at least one processor is configured to determine whether to update the training dataset Doo to include an updated feature set F′ by removing the feature Xₖ from the feature set F of the training dataset Doo by: for each of an integer i from the integer i equals zero to the integer i equals Nₛₚₗᵢₜ: splitting the training dataset D₀₀ the integer i times to generate 2ⁱ split-datasets, wherein each split-dataset D_{i,j} of the 2ⁱ split-datasets is a number j dataset obtained by splitting the training dataset D₀₀ into the [symbol] split-datasets; for each of the number j from the number j equals zero to the number j equals 2ⁱ−1: training the machine learning model M with the split-dataset D′_{i,j} to generate a first trained model Model (D_{i,j}); removing the feature Xₖ from the feature set F of the split-dataset D_{i,j} to generate a sub-dataset D′_{i,j}; training the model M with the sub-dataset D′_{i,j} to generate a second trained model Model(D′_{i,j}); determining a first loss Loss(D_{i,j}) for the first trained model Model(D_{i,j}); determining a second loss Loss(D′_{i,j}) for the second trained model Model(D′_{i,j}); determining a difference in loss (DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and adding the difference in loss (DIL_{k,i,j}) for the feature Xₖ to a vector Vₖ for the feature Xₖ; for each vector Vₖ: applying an outlier analysis to the vector Vₖ to identify a number of outliers included in the vector Vₖ; and in response to the number of outliers identified in the vector Vₖ satisfying a threshold outlier number, updating the training dataset D₀₀ to include an updated feature set F′ by removing the feature Xₖ from the feature set F of the training dataset D₀₀.

In some non-limiting embodiments or aspects, the at least one processor is configured to apply the outlier analysis to the vector Vₖ to identify the number of outliers included in the vector Vₖ by calculating a mean μ and a standard deviation σ of the difference in loss (DIL_{k,i,j}) for the feature Xₖ in the vector Vₖ for the feature Xₖ, and wherein an element of the vector Vₖ for the feature Xₖ is determined as an outlier in response to that element being a point outside the range (μ−3σ,μ+3σ).

In some non-limiting embodiments or aspects, the threshold outlier number is one.

In some non-limiting embodiments or aspects, the training dataset D₀₀ includes prior transaction data associated with a plurality of prior transactions processed in an electronic payment network during the time range [T₀, T].

In some non-limiting embodiments or aspects, the at least on processor is further configured to: receive current transaction data associated with a current transaction initiated in the electronic payment network, wherein the current transaction data includes the updated feature set F′, and wherein the updated feature set F′ includes parameters associated with the current transaction; process, using the trained machine learning model M′, the current transaction data to determine whether to authorize or deny the current transaction; and authorize or deny, in the electronic payment network, the current transaction.

According to some non-limiting embodiments or aspects, provided is a computer program product comprising at least one non-transitory computer-readable medium including program instructions that, when executed by at least one processor, cause the at least one processor to: obtain a machine learning model, a training dataset including a time range and a feature set including a number of features, and a number of times to split the training dataset; for each feature in the feature set, determine, based on a difference between a first trained model including the machine learning model trained on the training dataset with that feature and a second trained model including the machine learning model trained on the training dataset without that feature, whether to update the training dataset to include an updated feature set by removing the feature from the feature set of the training dataset; train the machine learning model on the training dataset including the updated feature set to generate a trained machine learning model; and provide the trained machine learning model.

In some non-limiting embodiments or aspects, for each feature in the feature set, the program instructions, when executed by the at least one processor, cause the at least one processor to determine whether to update the training dataset to include an updated feature set by removing the feature from the feature set of the training dataset by: for each of an integer i from the integer i equals zero to the integer i equals the number of time to split the training data: splitting the training dataset the integer i times to generate 2ⁱ split-datasets, wherein each split-dataset of the 2ⁱ split-datasets is a number j dataset obtained by splitting the training dataset into the [symbol] split-datasets; for each of the number j from the number j equals zero to the number j equals 2¹−1: training the machine learning model with the split-dataset to generate a first trained model; removing the feature rom the feature set of the split-dataset to generate a sub-dataset; training the model with the sub-dataset to generate a second trained model; determining a first loss for the first trained model); determining a second loss for the second trained model; determining a difference in loss between the first loss for the first trained model and the second loss for the second trained model for the feature; and adding the difference in loss for the feature to a vector for the feature; for each vector: applying an outlier analysis to the vector to identify a number of outliers included in the vector; and in response to the number of outliers identified in the vector satisfying a threshold outlier number, updating the training dataset to include an updated feature set by removing the feature from the feature set of the training dataset.

In some non-limiting embodiments or aspects, the program instructions, when executed by the at least one processor, cause the at least one processor to apply the outlier analysis to the vector to identify the number of outliers included in the vector by calculating a mean u and a standard deviation σ of the difference in loss for the feature in the vector for the feature, and wherein an element of the vector for the feature is determined as an outlier in response to that element being a point outside the range (μ−3σ,μ+3σ).

In some non-limiting embodiments or aspects, the threshold outlier number is one.

In some non-limiting embodiments or aspects, the training dataset includes prior transaction data associated with a plurality of prior transactions processed in an electronic payment network during the time range.

In some non-limiting embodiments or aspects, the program instructions, when executed by the at least one processor, further cause the at least one processor to: receive current transaction data associated with a current transaction initiated in the electronic payment network, wherein the current transaction data includes the updated feature set, and wherein the updated feature set includes parameters associated with the current transaction; process, using the trained machine learning model, the current transaction data to determine whether to authorize or deny the current transaction; and authorize or deny, in the electronic payment network, the current transaction.

According to some non-limiting embodiments or aspects, provided is a method, including: obtaining, with at least one processor, a machine learning model M, a training dataset D₀₀ including a time range [T₀, T] and a feature set F including a number k of features X, and a number Nₛₚₗᵢₜ times to split the training dataset D₀₀; for each feature Xₖ in the feature set F: for each of an integer i from the integer i equals zero to the integer i equals Nₛₚₗᵢₜ: splitting, with the at least one processor, the training dataset D₀₀ the integer i times to generate 2ⁱ split-datasets, wherein each split-dataset D_{i,j} of the 2ⁱ split-datasets is a number j dataset obtained by splitting the training dataset D₀₀ into the [symbol] split-datasets; for each of the number j from the number j equals zero to the number j equals 2ⁱ−1: training, with the at least one processor, the machine learning model M with the split-dataset D′_{i,j} to generate a first trained model Model(D_{i,j}); removing, with the at least one processor, the feature Xₖ from the feature set F of the split-dataset D_{i,j} to generate a sub-dataset D′_{i,j}; training, with the at least one processor, the model M with the sub-dataset D′_{i,j} to generate a second trained model Model(D′_{i,j}); determining, with the at least one processor, a first loss Loss(D_{i,j}) for the first trained model Model(D_{i,j}); determining, with the at least one processor, a second loss Loss(D′_{i,j}) for the second trained model Model(D′_{i,j}); determining, with the at least one processor, a difference in loss (DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and adding, with the at least one processor, the difference in loss (DIL_{k,i,j}) for the feature Xₖ to a vector Vₖ for the feature Xₖ; for each vector Vₖ: applying, with the at least one processor, an outlier analysis to the vector Vₖ to identify a number of outliers included in the vector Vₖ; and in response to the number of outliers identified in the vector Vₖ satisfying a threshold outlier number, updating, with the at least one processor, the training dataset D₀₀ to include an updated feature set F′ by removing the feature Xₖ from the feature set F of the training dataset D₀₀; training, with the at least one processor, the machine learning model M on the training dataset D₀₀ including the updated feature set F′ to generate a trained machine learning model M′; and providing, with the at least one processor, the trained machine learning model M′.

Further embodiments or aspects are set forth in the following numbered clauses:

Clause 1: A method, comprising: obtaining, with at least one processor, a machine learning model M, a training dataset D₀₀ including a time range [T₀, T] and a feature set F including a number k of features X, and a number Nₛₚₗᵢₜ of times to split the training dataset D₀₀; for each feature Xₖ in the feature set F, determining, with the at leastk one processor, based on a difference between a first trained model Model(D) including the machine learning model M trained on the training dataset D₀₀ with that feature Xₖ and a second trained model Model(D′) including the machine learning model M trained on the training dataset D₀₀ without that feature Xₖ, whether to update the training dataset D₀₀ to include an updated feature set F′ by removing the feature Xₖ from the feature set F of the training dataset Doo; training, with the at least one processor, the machine learning model M on the training dataset D₀₀ including the updated feature set F′ to generate a trained machine learning model M′; and providing, with the at least one processor, the trained machine learning model M′.

Clause 2: The method of clause 1, wherein for each feature Xₖ in the feature set F, determining whether to update the training dataset D₀₀ to include an updated feature set F′ by removing the feature Xₖ from the feature set F of the training dataset D₀₀ may include: for each of an integer i from the integer i equals zero to the integer i equals Nₛₚₗᵢₜ: splitting the training dataset D₀₀ the integer i times to generate 2ⁱ split-datasets, wherein each split-dataset D_{i,j} of the 2i split-datasets is a number j dataset obtained by splitting the training dataset D₀₀ into the 2ⁱ split-datasets; for each of the number j from the number j equals zero to the number j equals 2ⁱ−1: training the machine learning model M with the split-dataset D_{i,j} to generate a first trained model Model(Dᵢⱼ); removing the feature Xₖ from the feature set F of the split-dataset Dᵢⱼ to generate a sub-dataset D′_{i,j}; training the model M with the sub-dataset D′_{i,j} to generate a second trained model Model(D′ᵢⱼ); determining a first loss Loss(D′_{i,j}) for the first trained model Model(D_{i,j}); determining a second loss Loss(D′_{i,j}) for the second trained model Model(D′_{i.j}); determining a difference in loss (DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and adding the difference in loss (DIL_{k,i,j}) for the feature Xₖ to a vector Vₖ for the feature Xₖ; for each vector Vₖ: applying an outlier analysis to the vector Vₖ to identify a number of outliers included in the vector Vₖ; and in response to the number of outliers identified in the vector Vₖ satisfying a threshold outlier number, updating the training dataset D₀₀ to include an updated feature set F′ by removing the feature Xₖ from the feature set F of the training dataset D₀₀.

Clause 3: The method of clause 1 or 2, wherein applying the outlier analysis to the vector Vₖ to identify the number of outliers included in the vector Vₖ includes calculating a mean μ and a standard deviation σ of the difference in loss (DIL_{k,i,j}) for the feature Xₖ in the vector Vₖ for the feature Xₖ, and wherein an element of the vector Vₖ for the feature Xₖ is determined as an outlier in response to that element being a point outside the range (μ−3σ, μ3σ).

Clause 4: The method of any of clauses 1-3, wherein the threshold outlier number is one.

Clause 5: The method of any of clauses 1-4, wherein the training dataset Doo includes prior transaction data associated with a plurality of prior transactions processed in an electronic payment network during the time range [T₀, T].

Clause 6: The method of any of clauses 1-5, further comprising: receiving, with the at least one processor, current transaction data associated with a current transaction initiated in the electronic payment network, wherein the current transaction data includes the updated feature set F′, and wherein the updated feature set F′ includes parameters associated with the current transaction; processing, with the at least one processor, using the trained machine learning model M′, the current transaction data to determine whether to authorize or deny the current transaction; and authorizing or denying, with the at least one processor, in the electronic payment network, the current transaction.

Clause 7: A system, comprising: at least one processor coupled to a memory and configured to: obtain a machine learning model M, a training dataset D₀₀ including a time range [T₀, T] and a feature set F including a number k of features X, and a number Nₛₚₗᵢₜ of times to split the training dataset D₀₀; for each feature Xₖ in the feature set F, determine, based on a difference between a first trained model Model(D) including the machine learning model M trained on the training dataset D₀₀ with that feature Xₖ and a second trained model Model(D′) including the machine learning model M trained on the training dataset D₀₀ without that feature Xₖ, whether to update the training dataset Doo to include an updated feature set F′ by removing the feature Xₓ from the feature set F of the training dataset D₀₀; train the machine learning model M on the training dataset D₀₀ including the updated feature set F′ to generate a trained machine learning model M′; and provide the trained machine learning model M′.

Clause 8; The system of clause 7, wherein for each feature Xₖ in the feature set F, the at least one processor is configured to determine whether to update the training dataset D₀₀ to include an updated feature set F′ by removing the feature Xₖ from the feature set F of the training dataset D₀₀ by: for each of an integer i from the integer i equals zero to the integer i equals Nₛₚₗᵢₜ: splitting the training dataset D₀₀ the integer i times to generate 2ⁱ split-datasets, wherein each split-dataset Dᵢⱼ of the 2ⁱ split-datasets is a number j dataset obtained by splitting the training dataset D₀₀ into the 2i split-datasets; for each of the number j from the number j equals zero to the number j equals ¹-1: training the machine learning model M with the split-dataset D_{i,j} to generate a first trained model Model(D_{i,j}); removing the feature Xₖ from the feature set F of the split-dataset D_{i,j} to generate a sub-dataset D′_{i,j}; training the model M with the sub-dataset D′_{i,j} to generate a second trained model Model(D′^{i,j}); determining a first loss Loss(D_{i,j}) for the first trained model Model(D_{i,j}); determining a second loss Loss(D′_{i,j}) for the second trained model Model (D′_{i,j}); determining a difference in loss (DIL_{k,ij}) between the first loss Loss(D_{i,j}) for the first trained model Model(D_{i,j}) and the second loss Loss(D′_{i,j}) for the second trained model Model (D′_{i,j}) for the feature Xₖ; and adding the difference in loss (DIL^{k,i,j}) for the feature Xₖ to a vector Vₖ for the feature Xₖ; for each vector V^{k}: applying an outlier analysis to the vector Vₖ to identify a number of outliers included in the vector Vₖ; and in response to the number of outliers identified in the vector Vₖ satisfying a threshold outlier number, updating the training dataset D₀₀ to include an updated feature set F′ by removing the feature Xₖ from the feature set F of the training dataset D₀₀.

Clause 9: The system of clause 7 or 8, wherein the at least one processor is configured to apply the outlier analysis to the vector Vₖ to identify the number of outliers included in the vector Vₖ by calculating a mean μ and a standard deviation σ of the difference in loss (DIL_{k,i,j}) for the feature Xₖ in the vector Vₖ for the feature Xₖ, and wherein an element of the vector Vₖ for the feature Xₖ is determined as an outlier in response to that element being a point outside the range (μ−3σ,μ+3σ).

Clause 10: The system of any of clauses 7-9, wherein the threshold outlier number is one.

Clause 11: The system of any of clauses 7-10, wherein the training dataset Doo includes prior transaction data associated with a plurality of prior transactions processed in an electronic payment network during the time range [T₀. T].

Clause 12: The system of any of clauses 7-11, wherein the at least on processor is further configured to: receive current transaction data associated with a current transaction initiated in the electronic payment network, wherein the current transaction data includes the updated feature set F′, and wherein the updated feature set F′ includes parameters associated with the current transaction; process, using the trained machine learning model M′, the current transaction data to determine whether to authorize or deny the current transaction; and authorize or deny, in the electronic payment network, the current transaction.

Clause 13: A computer program product comprising at least one non-transitory computer-readable medium including program instructions that, when executed by at least one processor, cause the at least one processor to: obtain a machine learning model, a training dataset including a time range and a feature set including a number of features, and a number of times to split the training dataset; for each feature in the feature set, determine, based on a difference between a first trained model including the machine learning model trained on the training dataset with that feature and a second trained model including the machine learning model trained on the training dataset without that feature, whether to update the training dataset to include an updated feature set by removing the feature from the feature set of the training dataset; train the machine learning model on the training dataset including the updated feature set to generate a trained machine learning model; and provide the trained machine learning model.

Clause 14: The computer program product of clause 13, wherein for each feature in the feature set, the program instructions, when executed by the at least one processor, cause the at least one processor to determine whether to update the training dataset to include an updated feature set by removing the feature from the feature set of the training dataset by: for each of an integer i from the integer i equals zero to the integer i equals the number of time to split the training data: splitting the training dataset the integer i times to generate 2ⁱ split-datasets, wherein each split-dataset of the 2ⁱ split-datasets is a number j dataset obtained by splitting the training dataset into the 2ⁱ split-datasets; for each of the number j from the number j equals zero to the number j equals 2ⁱ−1: training the machine learning model with the split-dataset to generate a first trained model; removing the feature rom the feature set of the split-dataset to generate a sub-dataset; training the model with the sub-dataset to generate a second trained model; determining a first loss for the first trained model); determining a second loss for the second trained model; determining a difference in loss between the first loss for the first trained model and the second loss for the second trained model for the feature; and adding the difference in loss for the feature to a vector for the feature; for each vector: applying an outlier analysis to the vector to identify a number of outliers included in the vector; and in response to the number of outliers identified in the vector satisfying a threshold outlier number, updating the training dataset to include an updated feature set by removing the feature from the feature set of the training dataset.

Clause 15: The computer program product of clause 13 or 14, wherein the program instructions, when executed by the at least one processor, cause the at least one processor to apply the outlier analysis to the vector to identify the number of outliers included in the vector by calculating a mean u and a standard deviation o of the difference in loss for the feature in the vector for the feature, and wherein an element of the vector for the feature is determined as an outlier in response to that element being a point outside the range (μ−3σ,μ+3σ).

Clause 16: The computer program product of any of clauses 13-15, wherein the threshold outlier number is one.

Clause 17: The computer program product of any of clauses 13-16, wherein the training dataset includes prior transaction data associated with a plurality of prior transactions processed in an electronic payment network during the time range.

Clause 18: The computer program product of any of clauses 13-17, wherein the program instructions, when executed by the at least one processor, further cause the at least one processor to: receive current transaction data associated with a current transaction initiated in the electronic payment network, wherein the current transaction data includes the updated feature set, and wherein the updated feature set includes parameters associated with the current transaction; process, using the trained machine learning model, the current transaction data to determine whether to authorize or deny the current transaction; and authorize or deny, in the electronic payment network, the current transaction.

Clause 19: A method, comprising: obtaining, D₀₀ including a time range [T₀, T] and a feature set F including a number k of features X, and a number Nₛₚₗᵢₜ times to split the training dataset D₀₀; for each feature Xₖ in the feature set F: for each of an integer i from the integer i equals zero to the integer i equals Nₛₚₗᵢₜ: splitting, with the at least one processor, the training dataset D₀₀ 7 the integer i times to generate 2ⁱ split-datasets, wherein each split-dataset Di_{,j} of the 2ⁱ split-datasets is a number j dataset obtained by splitting the training dataset D₀₀ into the 2ⁱ split-datasets; for each of the number j from the number j equals zero to the number j equals 2ⁱ−1: training, with the at least one processor, the machine learning model M with the split-dataset D_{i,j} to generate a first trained model Model(D_{i,j}); removing, with the at least one processor, the feature Xₖ from the feature set F of the split-dataset D_{i,j} to generate a sub-dataset D′_{i,j}; training, with the at least one processor, the model M with the sub-dataset D′_{i,j} to generate a second trained model Model(D′_{i,j}); determining, with the at least one processor, a first loss Loss(D_{i,j}) for the first trained model Model(D_{i,j}); determining, with the at least one processor, a second loss Loss(D′_{i,j}) for the second trained model Model(D′_{i,j}); determining, with the at least one processor, a difference in loss (DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and adding, with the at least one processor, the difference in loss (DIL_{k,i,j}) for the feature Xₖ to a vector Vₖ for the feature Xₖ; for each vector Vₖ: applying, with the at least one processor, an outlier analysis to the vector Vₖ to identify a number of outliers included in the vector Vₖ; and in response to the number of outliers identified in the vector Vₖ satisfying a threshold outlier number, updating, with the at least one processor, the training dataset D₀₀ to include an updated feature set F′ by removing the feature Xₓ from the feature set F of the training dataset D₀₀; training, with the at least one processor, the machine learning model M on the training dataset D₀₀ including the updated feature set F′ to generate a trained machine learning model M′; and providing, with the at least one processor, the trained machine learning model M′.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for removing “fake” features in deep learning models;

FIG. 4 is a diagram of an implementation of non-limiting embodiments or aspects of a process for removing “fake” features in deep learning models; and

FIG. 5 is a graph that plots a difference in loss vector for an example feature.

### DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” and/or “processor” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the terms “request,” “response,” “request message,” and “response message” may refer to one or more messages, data packets, signals, and/or data structures used to communicate data between two or more components or units.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Removal of “fake” features from a model may cause the model to appear to be inferior to a same model that keeps the “fake” features in a shorter evaluation time period, but for a longer term, such removal of “fake” features may be beneficial as their removal may make the model more robust and/or improve the model's prediction capability because the remaining features after removing the “fake” features are generally better at predicting the associated output.

In an example scenario in which a model is to be trained to predict an electricity usage (EU) per household with training data including features for temperature (Tem), electricity price (EP), and a feature “IceCreamConsumption”, which measures a daily consumption of ice cream per household, it may appear that “IceCreamConsumption” is a good predictive feature, as there may be a strong positive correlation between EU and “IceCreamConsumption”. However, if for some reason ice cream becomes very expensive and most households cannot afford ice cream, and other features remain the same, the model may underestimate EU because the model sees that “IceCreamConsumption” is significantly lower. Yet, the truth may be that EU is still very high. This is because the major factors that contribute to EU may be that people need to use electricity to get cool or warm air in the house with air conditioners or heaters, and such factors are not related to “IceCreamConsumption” at all. Accordingly, in this example scenario, “IceCreamConsumption” should be considered as a “fake” feature. This is a “toy” example, and the “fake” feature in this example scenario is straightforward to understand, but in real-world deep learning applications, “fake” features may be quite “hidden” and may not be easily to be detected/revealed.

To effectively detect and remove “fake” features—which may appear to be “strong” at prediction only within certain time periods, but may lack the ability of being generally good for predicting a target, non-limiting embodiments or aspects of the present disclosure provide methods, systems, and computer program products that may obtain a machine learning model M, a training dataset D₀₀ including a time range [T₀, T] and a feature set F including a number k of features X, and a number Nsplit of times to split the training dataset D₀₀; for each feature Xₖ in the feature set F, determine, based on a difference between a first trained model Model(D) including the machine learning model M trained on the training dataset Doo with that feature Xₖ and a second trained model Model(D′) including the machine learning model M trained on the training dataset D₀₀ without that feature Xₖ, whether to update the training dataset D₀₀ to include an updated feature set F′ by removing the feature Xₖ from the feature set F of the training dataset D₀₀; the train machine learning model M on the training dataset D₀₀ including the updated feature set F′ to generate a trained machine learning model M′; and provide the trained machine learning model M′.

In this way, non-limiting embodiments or aspects of the present disclosure may identify and remove “fake” features from a training dataset to provide a trained machine learning model that is more robust and/or has better prediction capability. For example, in contrast to “feature importance” methods, which are not able to remove “fake” features because these “fake” features may still appear to be very “important”, non-limiting embodiments or aspects of the present disclosure may reduce or eliminate “fake” features by incorporating a “difference in loss (DIL)” metric to evaluate the “fakeness” of a feature for a pair of datasets with one dataset including the evaluated feature and the other one excluding the evaluated feature, and evaluating feature “fakeness” at different scales by splitting the training dataset into smaller chunks at different scales. As an example, non-limiting embodiments or aspects of the present disclosure may train a deep learning model many times on a dataset that are obtained by splitting the whole training dataset into smaller chunks based on time/date. For each smaller dataset, the model may be trained on the data with all the features and trained on the data that excludes a feature to be evaluated for “fakeness”. If the DIL for these two models is significantly abnormal compared with other DIL values, it implies that the feature may be treated as a “fake” feature and removed from the training data. Whenever a “fake” feature is detected, that feature may be removed from training data and the process may move on to the next feature, with such process eventually going over each of the features and, after all features have been evaluated for “fakeness”, the remaining features may be normal features that have no or very little “fakeness”. Accordingly, a new deep learning model trained with the remaining features may be much more robust and may have much better prediction capability for applications such as fraud detection in electronic payment networks and/or the like.

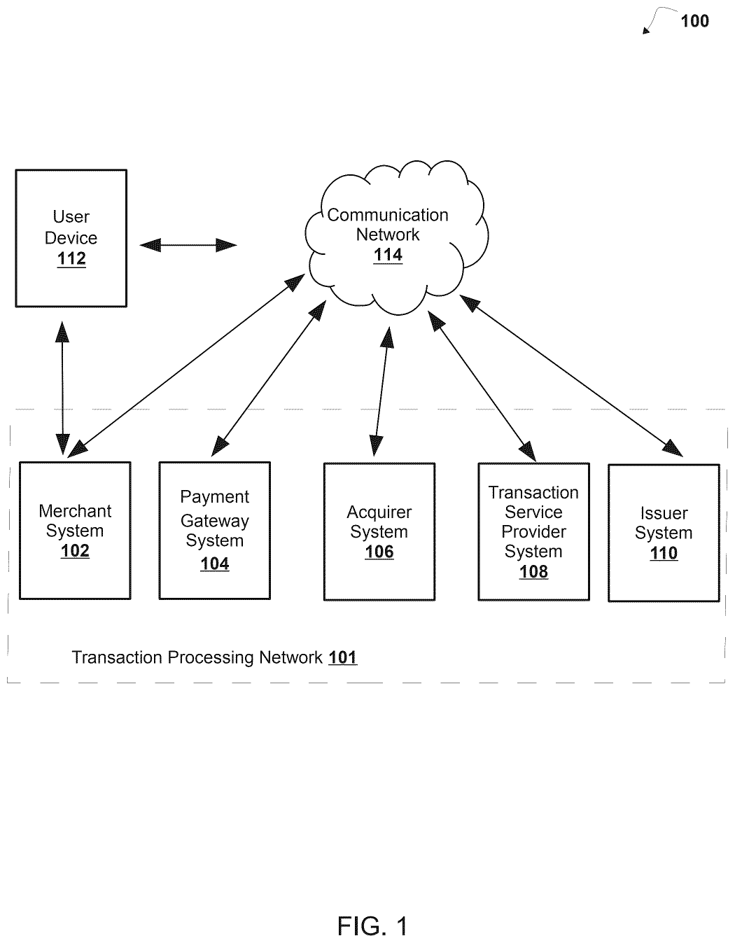

Referring now to FIG. 1, FIG. 1 is a diagram of an example environment 100 in which devices, methods, systems and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 114, etc.) and/or communicating information and/or data to payment gateway system 104, acquirer system 106, transaction service provider system 108, issuer system 110, and/or user device 112 (e.g., via communication network 114, etc.). Merchant system 102 may include a device capable of receiving information and/or data from user device 112 via a communication connection (e.g., an NFC communication connection, an RFID communication connection, a Bluetooth® communication connection, etc.) with user device 112 and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 114, etc.) and/or communicating information and/or data to merchant system 102, acquirer system 106, transaction service provider system 108, issuer system 110, and/or user device 112 (e.g., via communication network 114, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 114, etc.) and/or communicating information and/or data to merchant system 102, payment gateway system 104, transaction service provider system 108, issuer system 110, and/or user device 112 (e.g., via communication network 114, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 114, etc.) and/or communicating information and/or data to merchant system 102, payment gateway system 104, acquirer system 106, issuer system 110, and/or user device 112 (e.g., via communication network 114, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 (e.g., via communication network 114, etc.) and/or communicating information and/or data to merchant system 102, payment gateway system 104, acquirer system 106, transaction service provider system 108, and/or user device 112 (e.g., via communication network 114 etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issues a payment account or instrument (e.g., a credit account, a debit account, a credit card, a debit card, etc.) to a user (e.g., a user associated with user device 112, etc.).

In some non-limiting embodiments or aspects, transaction processing network 101 (e.g., an electronic payment network, etc.) includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 114, etc.) and/or communicating information and/or data to merchant system 102, payment gateway system 104, acquirer system 106, transaction service provider system 108, and/or issuer system 110 (e.g., via communication network 114, etc.). For example, user device 112 may include a client device and/or the like. In some non-limiting embodiments or aspects, user device 112 may be capable of receiving information (e.g., from merchant system 102, etc.) via a short-range wireless communication connection (e.g., an NFC communication connection, an RFID communication connection, a Bluetooth® communication connection, and/or the like), and/or communicating information (e.g., to merchant system 102, etc.) via a short-range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, an issuer bank application, and/or the like) stored and/or executed on user device 112. In some non-limiting embodiments or aspects, user device 112 may be associated with a sender account and/or a receiving account in a payment network for one or more transactions in the payment network.

Communication network 114 may include one or more wired and/or wireless networks. For example, communication network 114 may include a cellular network (e.g., a long-term evolution (LTE®) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 are provided as examples. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

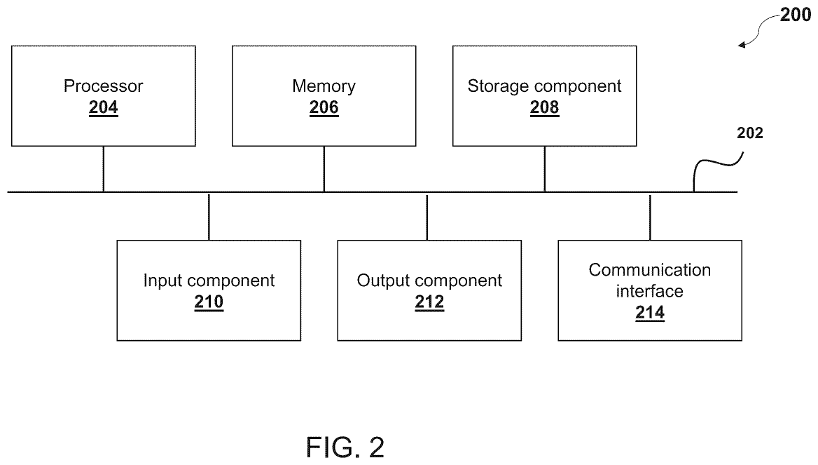

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 (e.g., a central processing unit (CPU), a graphics processing unit (GPU), etc.) executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

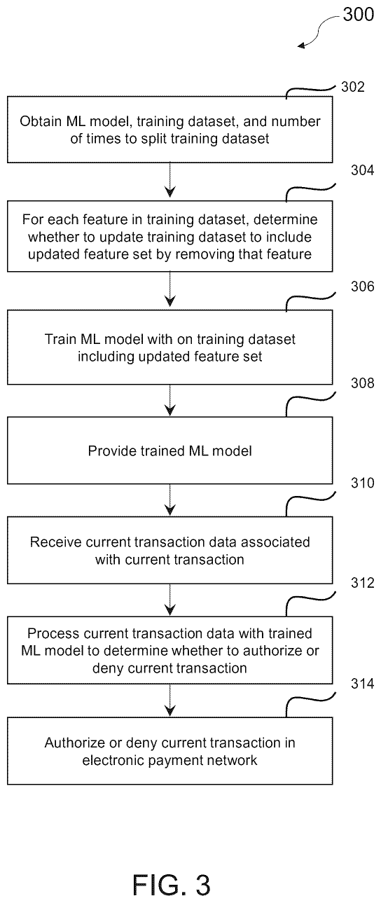

Referring now to FIG. 3, FIG. 3 is a flowchart of non-limiting embodiments or aspects of a process 300 for removing “fake” features in deep learning models. In some non-limiting embodiments or aspects, one or more of the steps of process 300 may be performed (e.g., completely, partially, etc.) by transaction service provider system 108 (e.g., one or more devices of transaction service provider system 108, etc.). In some non-limiting embodiments or aspects, one or more of the steps of process 300 may be performed (e.g., completely, partially, etc.) by another device or a group of devices separate from or including transaction service provider system 108, such as merchant system 102 (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112 (e.g., one or more devices of a system of user device 112).

As shown in FIG. 3, at step 302, process 300 includes obtaining a machine learning model, a training dataset including a time range and a feature set including a number of features, and a number of times to split the training dataset. For example, transaction service provider system 108 may obtain a machine learning model M, a training dataset D₀₀ including a time range [T₀, T] and a feature set F including a number k of features X, and a number N times to split the training dataset D₀₀.

A machine learning model M may include a neural network model (e.g., an estimator, a classifier, a prediction model, etc.). For example, transaction service provider system 108 may obtain a machine learning model M in an untrained state in which only a structure or architecture of the machine learning model M is defined (e.g., parameters of the machine learning model M are not yet determined, etc.). As an example, transaction service provider system 108 may train the machine learning model M using machine learning techniques as described herein below in more detail. In such an example, machine learning techniques may include supervised and/or unsupervised techniques, such as decision trees (e.g., gradient boosted decision trees), random forest algorithms, logistic regressions, artificial neural networks (e.g., convolutional neural networks (CNN), multi-layer perceptrons (MLP), recurrent neural networks (RNN), etc.), Bayesian statistics, Gaussian distributions, non-Gaussian distributions, chi-squared distributions, learning automata, Hidden Markov Modeling, linear classifiers, quadratic classifiers, association rule learning, and/or the like.

A training dataset D₀₀ may include prior transaction or event data associated with a plurality of prior transactions or events (e.g., a plurality of prior transactions processed in an electronic payment network during a time range [T₀, T], etc.). A time range [T₀, T] may include a range of dates and/or times, such as between Jan. 1, 2019 (e.g., 2019-01-01, etc.) and Jan. 1, 2022 (e.g., 2022-01-01, etc.), and/or the like. A feature set F including a number k of features X may include one or more features X corresponding to parameters of the plurality of prior transactions or events. For example, the prior transaction data may include parameters associated with a prior transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, and/or the like. A number Nₛₚₗᵢₜ times to split the training dataset D₀₀ may be a hyperparameter that can be set by a user.

As shown in FIG. 3, at step 304, process 300 includes, for each feature in the feature set, determining, based on a difference between a first trained model including the machine learning model trained on the training dataset with that feature and a second trained model including the machine learning model trained on the training dataset without that feature, whether to update the training dataset to include an updated feature set by removing the feature from the feature set of the training dataset. For example, transaction service provider system 108 may for each feature Xₖ in the feature set F, determine, based on a difference between a first trained model Model(D) including the machine learning model M trained on the training dataset D₀₀ with that feature Xₖ and a second trained model Model(D′) including the machine learning model M trained on the training dataset D₀₀ without that feature Xₖ, whether to update the training dataset Doo to include an updated feature set F′by removing the feature Xₖ from the feature set F of the training dataset D₀₀.

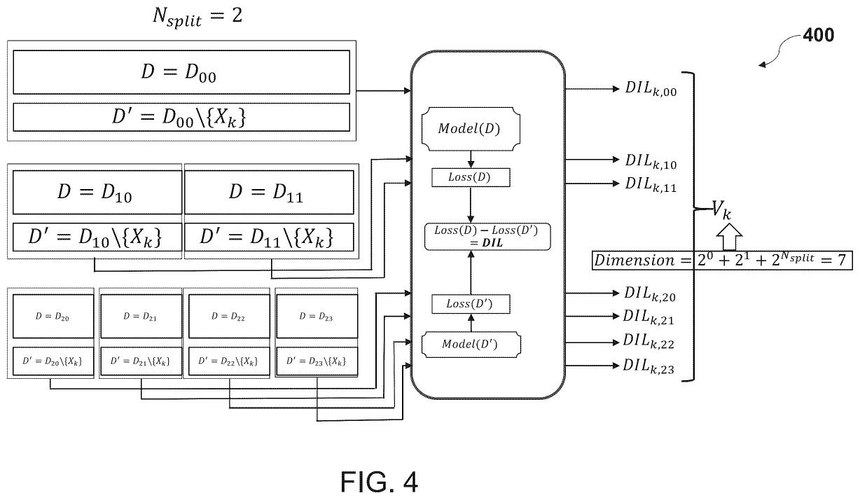

Referring now also to FIG. 4, FIG. 4 is a diagram of an implementation 400 of non-limiting embodiments or aspects of a process for removing “fake” features in deep learning models. A number of times to split the training dataset Nₛₚₗᵢₜ is set to two (2) in implementation 400 of FIG. 4 for purposes of illustration; however, non-limiting embodiments or aspects of the present disclosure are not limited thereto, and number of times to split the training dataset Nₛₚₗᵢₜ may be set to any desired number, such as one (1), two (2), three (3), four (4), five (5), one hundred (100), one thousand (1000), and/or like.

As shown in FIG. 4, for each feature Xₖ in the feature set F, transaction service provider system 108 may determine whether to update the training dataset Doo to include an updated feature set F′ by removing the feature Xₖ from the feature set F of the training dataset D₀₀ by: for each of an integer ifrom the integer i equals zero to the integer i equals Nₛₚₗᵢₜ, splitting the training dataset Doo the integer i times to generate 2ⁱ split-datasets, each split-dataset D_{i,j} of the ⁱ split-datasets being a number j dataset obtained by splitting the training dataset D₀₀ into the 2 split-datasets. For each of the number j from the number j equals zero to the number j equals 2ⁱ−1, transaction service provider system 108 may train the machine learning model M with the split-dataset D_{i,j} to generate a first trained model Model(D_{i,j}), remove the feature Xx from the feature set F of the split-dataset D_{i,j} to generate a sub-dataset D′_{i,j} (e.g., D′_{i,j}\{Xₖ}, etc.), train the model M with the sub-dataset D′_{i,j} to generate a second trained model Model(D′_{i,j}), determine a first loss Loss(D_{i,j}) for the first trained model Model(D_{i,j}), determine a second loss Loss(D′_{i,j}) for the second trained model Model(D′_{i,j}), determine a difference in loss (DIL_{k,i,j}) between the first loss Loss (D_{i,j}) for the first trained model Model(D_{i,j}) and the second loss Loss(D′_{i,j}) for the second trained model Model(D′i,j) for the feature Xₖ, and/or add the difference in loss (DIL_{k,ij}) for the feature Xₖ to a vector Vₖ for the feature Xₖ. For example, as shown in implementation 400 of FIG. 4, in which a number of times to split the training dataset Nₛₚₗᵢₜ is set to two (2), transaction service provider system 108 may generate a vector Vₖ=DIL_{k,00}, DIL_{k,10}, DIL_{k,11}, DIL_{k,20}, DIL_{k,21}, DIL_{k,22}, DIL_{k,23}.

For each vector Vₖ, transaction service provider system 108 may apply an outlier analysis to the vector Vₖ to identify a number of outliers included in the vector Vₖ. In response to the number of outliers identified in the vector Vₖ satisfying a threshold outlier number, transaction service provider system 108 may update the training dataset D₀₀ to include an updated feature set F′ by removing the feature Xₖ from the feature set F of the training dataset D₀₀.

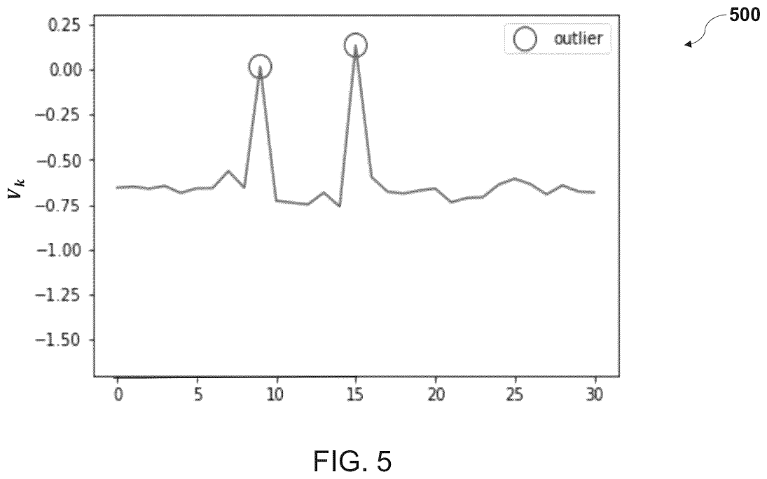

In some non-limiting embodiments or aspects, transaction service provider system 108 may apply the outlier analysis to the vector Vₖ to identify the number of outliers included in the vector Vₖ by calculating a mean u and a standard deviation σ of the difference in loss (DIL_{k,ij}) for the feature Xₖ in the vector Vₖ for the feature Xₖ, and an element of the vector Vₖ for the feature Xk may be determined by transaction service provider system 108 as an outlier in response to that element being a point outside the range (μ−3σ,μ+3σ). For example, and referring also to FIG. 5, which is a graph 500 that plots a difference in loss vector Vₖ for an example feature, a plot of Vₖ may ideally be almost flat; however, detection of an outlier in the plot may imply or indicate that the feature Xₖ is a “fake” feature. As an example, the threshold outlier number may be one (1); however, non-limiting embodiments or aspects of the present disclosure are not limited thereto, and the threshold outlier number may be set to any desired number, such as two (2), three (3), and/or the like.

In some non-limiting embodiments or aspects, transaction service provider system 108 may additionally, or alternatively, apply a machine learning technique for outlier detection to the vector Vₖ to identify the number of outliers included in the vector Vₖ (e.g., an Elliptic Envelope Algorithm, Isolation Forest Algorithm, One-class SVM Algorithm, Local Outlier Factor (LOF) Algorithm, etc.).

As shown in FIG. 3, at step 306, process 300 includes training the machine learning model on the training dataset including the updated feature set to generate a trained machine learning model. For example, transaction service provider system 108 may train the machine learning model M on the training dataset Doo including the updated feature set F′ to generate a trained machine learning model M′.

As shown in FIG. 3, at step 308, process 300 includes providing the trained machine learning model. For example, transaction service provider system 108 may provide the trained machine learning model M′. As an example, transaction service provider system 108 may store the trained machine learning model M′ in a data structure (e.g., a database, a linked list, a tree, etc.). In some non-limiting embodiments or aspects, the data structure is located within transaction service provider system 108 and/or external from (e.g., remote from) transaction service provider system 108. In some non-limiting embodiments or aspects, transaction service provider system 108 provides the trained machine learning model M′ to another system or device of transaction processing network 101, such as issuer system 110, and/or the like.

As shown in FIG. 3, at step 310, process 300 includes receiving current transaction data associated with a current transaction initiated in an electronic payment network. For example, transaction service provider system 108 may receive current transaction data associated with a current transaction initiated in an electronic payment network. As an example, the training dataset D₀₀ may include prior transaction data associated with a plurality of prior transactions processed in an electronic payment network during the time range [T₀, T]. In such an example, the current transaction data may include the updated feature set F′, and/or the updated feature set F′ may include parameters associated with the current transaction.

As shown in FIG. 3, at step 312, process 300 includes processing, using the trained machine learning model, the current transaction data to determine whether to authorize or deny the current transaction. For example, transaction service provider system 108 may process, using the trained machine learning model M′, the current transaction data to determine whether to authorize or deny the current transaction. As an example, transaction service provider system 108 may provide, as input to the trained machine learning model M′, the parameters associated with the current transaction in the updated feature set F′, and receive, as output from the trained machine learning model M′, an indication associated with whether to authorize or deny the current transaction. For example, the trained machine learning model M′ may include a fraud prediction model, and the indication may include a prediction (e.g., a probability, a binary output, a yes-no output, a score, a prediction score, etc.) that the current transaction is a fraudulent transaction.

As shown in FIG. 3, at step 314, process 300 includes authorizing or denying, in the electronic payment network, the current transaction. For example, transaction service provider system 108 may authorize or deny, in the electronic payment network, the current transaction. As an example, service provider system 108 may authorize, in the electronic payment network, the current transaction based on a prediction that the current transaction is not a fraudulent transaction. As an example, service provider system 108 may deny, in the electronic payment network, the current transaction based on a prediction that the current transaction is a fraudulent transaction.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method, comprising:
obtaining, with at least one processor, a machine learning model M, a training dataset Doo including a time range [T₀, T] and a feature set F including a number k of features X, and a number Nₛₚₗᵢₜ of times to split the training dataset D₀₀;
for each feature Xₖ in the feature set F, determining, with the at least one processor, based on a difference between a first trained model Model(D) including the machine learning model M trained on the training dataset D₀₀ with that feature Xₖ and a second trained model Model(D′) including the machine learning model M trained on the training dataset D₀₀ without that feature Xₖ, whether to update the training dataset D₀₀ to include an updated feature set F′ by removing the feature Xₖ from the feature set F of the training dataset D₀₀;
training, with the at least one processor, the machine learning model M on the training dataset D₀₀ including the updated feature set F′to generate a trained machine learning model M′; and
providing, with the at least one processor, a trained machine learning model M′.

2. The method of claim 1, wherein for each feature Xₖ in the feature set F, determining whether to update the training dataset D₀₀ to include an updated feature set F′ by removing the feature Xₖ from the feature set F of the training dataset D₀₀ may include:
for each of an integer i from the integer i equals zero to the integer i equals Nₛₚₗᵢₜ:
splitting the training dataset D₀₀ the integer i times to generate 2¹ split-datasets, wherein each split-dataset D_{i,j} of the 2ⁱ split-datasets is a number j dataset obtained by splitting the training dataset D₀₀ into the 2ⁱ split-datasets;
for each of the number j from the number j equals zero to the number j equals 2−1:
training the machine learning model M with the split-dataset D_{i,j} to generate a first trained model 0 Model (D_{i,j});
removing the feature Xₖ from the feature set F of the split-dataset D_{i,j} to generate a sub-dataset D′_{i,j};
training the model M with the sub-dataset D′_{i,j} to generate a second trained model Model(D′_{i,j});
determining a first loss Loss(D_{i,j}) for the first trained model Model(D_{i,j});
determining a second loss Loss(D′_{i,j}) for the second trained model Model (D′_{i,j});
determining a difference in loss (DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and
adding the difference in loss (DIL_{k,i,j}) for the feature Xₖ to a vector Vₖ for the feature Xₖ; and
for each vector Vₖ:
applying an outlier analysis to the vector Vₖ to identify a number of outliers included in the vector Vₖ; and
in response to the number of outliers identified in the vector Vₖ satisfying a threshold outlier number, updating the training dataset D₀₀ to include the updated feature set F′ by removing the feature XDₖ from the feature set F of the training dataset D₀₀.

3. The method of claim 2, wherein applying the outlier analysis to the vector Vₖ to identify the number of outliers included in the vector Vₖ includes calculating a mean μ and a standard deviation σ of the difference in loss (DIL_{k,i,j}) for the feature Xₖ in the vector Vₖ for the feature Xₖ, and wherein an element of the vector Vₖ for the feature Xₖ is determined as an outlier in response to that element being a point outside a range (μ−3σ,μ394 ).

4. The method of claim 2, wherein the threshold outlier number is one.

5. The method of claim 1, wherein the training dataset D₀₀ includes prior transaction data associated with a plurality of prior transactions processed in an electronic payment network during the time range [T₀, T].

6. The method of claim 5, further comprising:
receiving, with the at least one processor, current transaction data associated with a current transaction initiated in the electronic payment network, wherein the current transaction data includes the updated feature set F′, and wherein the updated feature set F′ includes parameters associated with the current transaction;
processing, with the at least one processor, using the trained machine learning model M′, the current transaction data to determine whether to authorize or deny the current transaction; and
authorizing or denying, with the at least one processor, in the electronic payment network, the current transaction.

7. A system, comprising:
at least one processor coupled to a memory and configured to:
obtain a machine learning model M, a training dataset D₀₀ including a time range [T₀, T] and a feature set Fincluding a number k of features X, and a number Nₛₚₗᵢₜ of times to split the training dataset D₀₀;
for each feature Xₖ in the feature set F, determine, based on a difference between a first trained model Model(D) including the machine learning model M trained on the training dataset Doo with that feature Xₖ and a second trained model Model(D′) including the machine learning model M trained on the training dataset Doo without that feature Xk, whether to update the training dataset D₀₀ to include an updated feature set F′ by removing the feature Xₖ from the feature set F of the training dataset D₀₀;
train the machine learning model M on the training dataset D₀₀ including the updated feature set F′ to generate a trained machine learning model M′; and
provide a trained machine learning model M′.

8. The system of claim 7, wherein for each feature Xₖ in the feature set F, the at least one processor is configured to determine whether to update the training dataset D₀₀ to include the updated feature set F′ by removing the feature Xₖ from the feature set F of the training dataset D₀₀ by:
for each of an integer i from the integer i equals zero to the integer i equals Nₛₚₗᵢₜ:
splitting the training dataset D₀₀ the integer i times to generate 2ⁱ split-datasets, wherein each split-dataset D_{i,j} of the 2ⁱ split-datasets is a number j dataset obtained by splitting the training dataset D₀₀ into the 2ⁱ split-datasets;
for each of the number j from the number j equals zero to the number j equals 2ⁱ−1:
training the machine learning model M with the split-dataset D_{i,j} to generate a first trained model Model(D_{i,j});
removing the feature Xₖ from the feature set F of the split-dataset D_{i,j} to generate a sub-dataset D′_{i,j};
training the model M with the sub-dataset D′_{i,j} to generate a second trained model Model(D′_{i,j});
determining a first loss Loss(D_{i,j}) for the first trained model Model(D_{i,j});
determining a second loss Loss(D′_{i,j}) for the second trained model Model(D′_{i,j});
determining a difference in loss(DIL_{k,ij}) between the first loss Loss(D_{i,j}) for the first trained model Model(D_{i,j}) and the second loss Loss(D′_{i,j}) for the second trained model Model(D′_{i,j}) for the feature Xₖ; and
adding the difference in loss (DIL_{k,i,j}) for the feature Xₖ to a vector Vₖ for the feature Xₖ; and
for each vector Vₖ:
applying an outlier analysis to the vector Vₖ to identify a number of outliers included in the vector Vₖ; and
in response to the number of outliers identified in the vector VDₖ satisfying a threshold outlier number, updating the training dataset D₀₀ to include the updated feature set F′ by removing the feature Xₖ from the feature set F of the training dataset D₀₀.

9. The system of claim 8, wherein the at least one processor is configured to apply the outlier analysis to the vector Vₖ to identify the number of outliers included in the vector Vₖ by calculating a mean μ and a standard deviation σ of the difference in loss (DIL_{k,i,j}) for the feature Xₖ in the vector Vₖ for the feature Xₖ, and wherein an element of the vector Vₖ for the feature Xk is determined as an outlier in response to that element being a point outside a range (μ−3σ,μ+3σ).

10. The system of claim 8, wherein the threshold outlier number is one.

11. The system of claim 7, wherein the training dataset D₀₀ includes prior transaction data associated with a plurality of prior transactions processed in an electronic payment network during the time range [T₀, T].

12. The system of claim 11, wherein the at least on processor is further configured to:
receive current transaction data associated with a current transaction initiated in the electronic payment network, wherein the current transaction data includes the updated feature set F′, and wherein the updated feature set F′ includes parameters associated with the current transaction;
process, using the trained machine learning model M′, the current transaction data to determine whether to authorize or deny the current transaction; and
authorize or deny, in the electronic payment network, the current transaction.

13. A computer program product comprising at least one non-transitory computer-readable medium including program instructions that, when executed by at least one processor, cause the at least one processor to:
obtain a machine learning model, a training dataset including a time range and a feature set including a number of features, and a number of times to split the training dataset;
for each feature in the feature set, determine, based on a difference between a first trained model including the machine learning model trained on the training dataset with that feature and a second trained model including the machine learning model trained on the training dataset without that feature, whether to update the training dataset to include an updated feature set by removing the feature from the feature set of the training dataset;
train the machine learning model on the training dataset including the updated feature set to generate a trained machine learning model; and
provide the trained machine learning model.

14. The computer program product of claim 13, wherein for each feature in the feature set, the program instructions, when executed by the at least one processor, cause the at least one processor to determine whether to update the training dataset to include an updated feature set by removing the feature from the feature set of the training dataset by:
for each of an integer i from the integer i equals zero to the integer i equals the number of time to split the training data:
splitting the training dataset the integer i times to generate 2ⁱ split-datasets, wherein each split-dataset of the 2ⁱ split-datasets is a number j dataset obtained by splitting the training dataset into the 2ⁱ split-datasets;
for each of the number j from the number j equals zero to the number j equals 2ⁱ−1:
training the machine learning model with the split-dataset to generate a first trained model;
removing the feature rom the feature set of the split-dataset to generate a sub-dataset;
training the model with the sub-dataset to generate a second trained model;
determining a first loss for the first trained model;
determining a second loss for the second trained model;
determining a difference in loss between the first loss for the first trained model and the second loss for the second trained model for the feature; and
adding the difference in loss for the feature to a vector for the feature; and
for each vector:
applying an outlier analysis to the vector to identify a number of outliers included in the vector; and
in response to the number of outliers identified in the vector satisfying a threshold outlier number, updating the training dataset to include an updated feature set by removing the feature from the feature set of the training dataset.

15. The computer program product of claim 14, wherein the program instructions, when executed by the at least one processor, cause the at least one processor to apply the outlier analysis to the vector to identify the number of outliers included in the vector by calculating a mean μ and a standard deviation σ of the difference in loss for the feature in the vector for the feature, and wherein an element of the vector for the feature is determined as an outlier in response to that element being a point outside a range (μ−3σ,μ+3σ).

16. The computer program product of claim 14, wherein the threshold outlier number is one.

17. The computer program product of claim 13, wherein the training dataset includes prior transaction data associated with a plurality of prior transactions processed in an electronic payment network during the time range.

18. The computer program product of claim 17, wherein the program instructions, when executed by the at least one processor, further cause the at least one processor to:
receive current transaction data associated with a current transaction initiated in the electronic payment network, wherein the current transaction data includes the updated feature set, and wherein the updated feature set includes parameters associated with the current transaction;
process, using the trained machine learning model, the current transaction data to determine whether to authorize or deny the current transaction; and
authorize or deny, in the electronic payment network, the current transaction.
